(19) United States
(12) Patent Application Publication
(10) Pub. No.: US 2012/0215935 A1
(43) Pub. Date: Aug. 23, 2012

(54) METHODS AND SYSTEMS RELATED TO INTERNET RADIO BROADCASTS

(76) Inventor: Randy Woods, Apopka, FL (US)

(21) Appl. No.: 13/369,276

(22) Filed: Feb. 8, 2012

Related U.S. Application Data
(60) Provisional application No. 61/440,839, filed on Feb. 8, 2011.

(51) Int. Cl. G06F 15/16

(52) U.S. Cl. 709/231

(57) ABSTRACT

A method for injecting listener-selected content into an internet radio data stream supplied via an internet web site to a listener accessing the internet web site. The method comprises storing musical and non-musical content items in a data base, presenting the listener with a list of the content items, requesting the listener to select desired content items and streaming the desired content items to the listener.

### CLAIM OF PRIORITY

This patent application claims the benefit under Section 119(e) of the provisional patent application assigned Application No. 61/440839 filed on Feb. 8, 2011, which is incorporated by reference herein.

### FIELD OF THE INVENTION

The present invention relates to methods and systems for use in internet radio broadcasts.

### BACKGROUND OF THE INVENTION

Local (terrestrial) radio is just that. It is a localized and broadcast-limited in geographical scope due to its limited broadcast coverage area. Local radio broadcasts include local personalities (disk jockeys) who discuss local information, including news, weather, events, etc. Local radio further includes advertisements and public service announcements that refer to local businesses and events.

Satellite and internet radio communications systems are broader in their geographical coverage. Internet radio coverage is global. In the US, satellite radio coverage includes the entire lower 48 states. In fact, its FCC (Federal Communications Commission) license mandates that its content be national in scope. No localization is permitted.

Personalized internet radio, such as Pandora, is also global in its scope and personal in its music content, but does not include any localized personalities or content.

Internet radio simulcasts of local radio programs are global in their coverage, but local in their content. You can listen anywhere in the world, but you will hear content specific to the local region where the radio program originated.

Personalized Internet radio streams, such as Pandora or Slacker, play music elements in a fashion sounding similar to a jukebox or CD player set on “random playback”. One song plays to completion. Commonly the end of the song is accompanied by a “click” sound followed by a random amount of silence, anywhere from one to many seconds. Finally another song starts playing, again commonly accompanied by a click sound. Often the songs vary in their volume level and tonal balance.

Radio stations, on the other hand, transition or segue their song endings (referred to as “outros”) to the beginning of the next song (referred to as “intros”) to create a smooth transition and keep the listener engaged. Broadcast radio stations also work very hard and spend much money on equipment to balance the level and tonal quality of the music played.

Personalized radio, such as Pandora, allows the listener to enter artists, composers, or songs as a baseline or reference for the type of music the listener wants to hear. The system analyzes the listener's selections and automatically selects similar song selections for streaming to the listener.

Radio stations have staff music directors and program directors who analyze songs based on professional experience and enter the songs they think are the best and will be most enjoyed by their listening audience into broadcast rotation play list. After a song has had a certain number of air plays, station personnel conduct a survey in which they play various music selections and ask a group of listeners or potential listeners to rate these music selections. The station staff also uses internet music rating services to secure additional input from their current or potential listenership.

The disadvantage of the Pandora-like approach is that many assumptions are made that cause the system to deliver music the listener is not interested in hearing or does not enjoy. For example, the listener may have enjoyed a couple songs performed by a specific artist and therefore enters the name of that artist. The system takes the metrics associated with that artist (metrics such as country, acoustic, or up-tempo) and selects other songs, with the same metrics, that the listener may like. Of course, the listener may not like the selected songs. After the listener enters a few artist selections, the prior art system may take the listener in a completely different musical direction than was originally intended.

Some personalized radio systems allow the listener to make changes to her/his profile when listening on a computer, but when listening on a smart phone, for example, further customization is not available. The result may be streaming music that is different from what the listener had intended.

Most internet based, personalized radio systems have only one level of audio quality and a corresponding data bandwidth requirement. If the listener has a large data bandwidth available, the music plays flawlessly. If in the case of a mobile device, e.g., a smart phone, as the user traverses a mobile phone coverage area, the data connection may change from a 3G connection to a slower connection, such as a non-3G connection. At this slower data rate the available bandwidth may not be adequate to deliver the audio stream without occasional drop-outs.

If a business enterprise wants to have music or other audio content played at their place of business, the business must pay for a music copyright license (royalties) if the music is played from more than two speakers. Service providers offer businesses various options under which music selections are provided and the royalties due are tracked for that business. However, these providers offer only a limited set of music selection options. In years past the most popular provider was Muzak. More recently, XM satellite radio offers their music services to businesses at a higher rate to cover the costs of music licensing.

The main limitation of this scheme is the limited range of commercial free music selections or styles that are provided. If the business wants to interject its own announcements or marketing information, it must either interrupt the music, or design and construct its own music delivery system, while tracking and paying the music license fees.

### BRIEF DESCRIPTION OF THE FIGURES

FIG. 1 illustrates a partial block diagram and partial flowchart for supplying local content to the system of the present invention.

FIGS. 2A and 2B illustrate menu displays for listener selection of the types of local content.

FIG. 3 illustrates a waveform for a portion of a musical selection.

FIG. 4 illustrates a display of time segments of the musical selection of FIG. 3.

FIG. 5 illustrates a display of a software application used to process the dynamic and tonal content of a song.

FIG. 6 illustrates several different musical selection rotation patters as a function of time spent listening.

FIG. 7 illustrates a display of music selection metrics for a listener to use in selecting the type of music to be streamed to the listener.

FIG. 8 illustrates a computer system for implementing the teachings of the present invention.

FIGS. 9-11 illustrate flowcharts for execution by the computer system of FIG. 8 to implement various embodiments of the invention.

### DETAILED DESCRIPTION OF THE INVENTION

Before describing in detail methods and systems related to internet radio according to the present inventions, it should be observed that the present invention resides in a novel and non-obvious combination of elements and method steps. Accordingly, they have been represented by conventional elements and method steps in the drawings and the specification. The elements and steps conventionally known in the art are described in lesser detail, and elements and steps pertinent to understanding the invention are described in greater detail.

The following preferred embodiments are applications of the present invention and are not intended to define limits of the elements or method steps or uses of the invention, but only to provide exemplary constructions. Many variations can be made to the described methods and systems within the scope of the presented claims.

Personalized Radio With Injection of Local Personalities, e.g., News, Weather, Emergency Information, and Advertisements

This embodiment of the present invention offers a personalized radio experience by injecting local personalities, local news, local weather, local emergency information, and local advertising into a music stream, such as a traditional globally-scoped internet radio.

Locally-scoped personalities (disk jockey) or local information content is recorded or gathered and uploaded to the system. To permit the injection of local personalities and information, the location of the listener can be either automatically or manually determined. According to another embodiment, the listener can manually enter allocation other than the listener's current physical location, e.g., the listener's hometown. The system locates the content scope for a region or city that is closest to the listener's actual or requested location. That content is injected into the data/music stream during the next available time slot or into a pre-determined time slot. The listener then hears the local content of interest intermixed with the listener's music.

As can be appreciated, the systems and methods of the present invention add an element or feature of local radio to the global scope of internet radio. Personalities from any location can upload voice tracks (vocal recordings, including such recordings of local interest) to the system of the invention. During the voice tracking process, the on-air personality (talent) talks about localized content for a target area, just as an on-air personality does during a local terrestrial radio broadcast. Further, the target area may or may not be the area where the talent resides. In such a case, however, the talent must of course be informed of target area information so that the talent can speak about it. After the recording has been completed, the vocal recording is uploaded to the system of the invention.

For example, news and weather reports are recorded for localized areas and uploaded into the system. Emergency information, including but not limited to alerts from NOAA and law enforcement entities, is also injected into the system.

The uploaded content can be in either audio or data format. Text-to-speech technology can be used to convert text data to audio recordings for transmission over the internet radio channel, i.e., the audio recordings have to be in a digital format for transmission over the internet.

Commercials and other paid-for content for local or regional businesses can also be prerecorded and uploaded to the system.

At the listener's end, the listener specifies his/her current location by manually entering that location into the system. Alternatively, the current location can be automatically determined according to a number of methods including geographic lookup using the listener's computer IP address, or location information gathered from a cell phone or from a GPS(Global Positioning System) receiver or from a listeners zip code. Whether manually entered or automatically determined, the location information is input to the system.

Responsive to the determined location information, the system selects the previously uploaded content for the local area that is closest to the desired area and queues it for playback on the listener's system between other content played by the system.

The location-based information can be queued for playback either as soon as possible or at a predetermined time. Emergency information, for example, is queued based on the urgency of the content. For example, a tornado warning immediately interrupts the audio stream. A boil water alert can be queued to play when the currently playing song ends or at predetermined times.

There may be times when only national or regionally scoped content is available for playback to listeners. In that case, the listener receives the national or regionally scoped content at the predetermined times. As additional localized content is uploaded, it will be played back (streamed) for all listeners who have selected that local area for delivery of local content.

Because not every listener wants to hear spoken announcements from a personality, the system allows the listener to opt in or out of receiving personality injections (or any other local information). In the case where a listener opts out, the system fills the designated local content time slots with other program material such as music or other content that is not locally oriented.

In another embodiment, the system does not have predetermined time slots for local information. Thus the schedule of musical selections continues without inserting any local content information. This feature is one of the added benefits of a personalized internet radio system such as taught by the present invention, that is, eliminating from the data stream any content that the listener does not want to hear and adding to the data stream local content that the listener does want to hear.

The listener can opt in or out for receiving one or more of news, weather emergency information, or other local content. The listener can also select specific local information injections at any one of various presented levels. For example, the listener is presented with options to select the content level, e.g., national, regional, state, local, or various combinations. According to other embodiments, the listener can select a location for which local content is delivered, the location different from the physical location of the listener. In another embodiment the listener can select delivered content items provided by specific local personalities, i.e., providing the listener with the option to select local content provided by certain local personalities and not select content provided by other local personalities.

Different embodiments of the system permit the listener to select different types of local, regional and national content. For example, a listener can select vocal tracks of a local DJ in the Orlando, Fla. for streaming to the listener's listening device. This listener can further select national weather content, Orlando, Fla. weather content or no weather content.

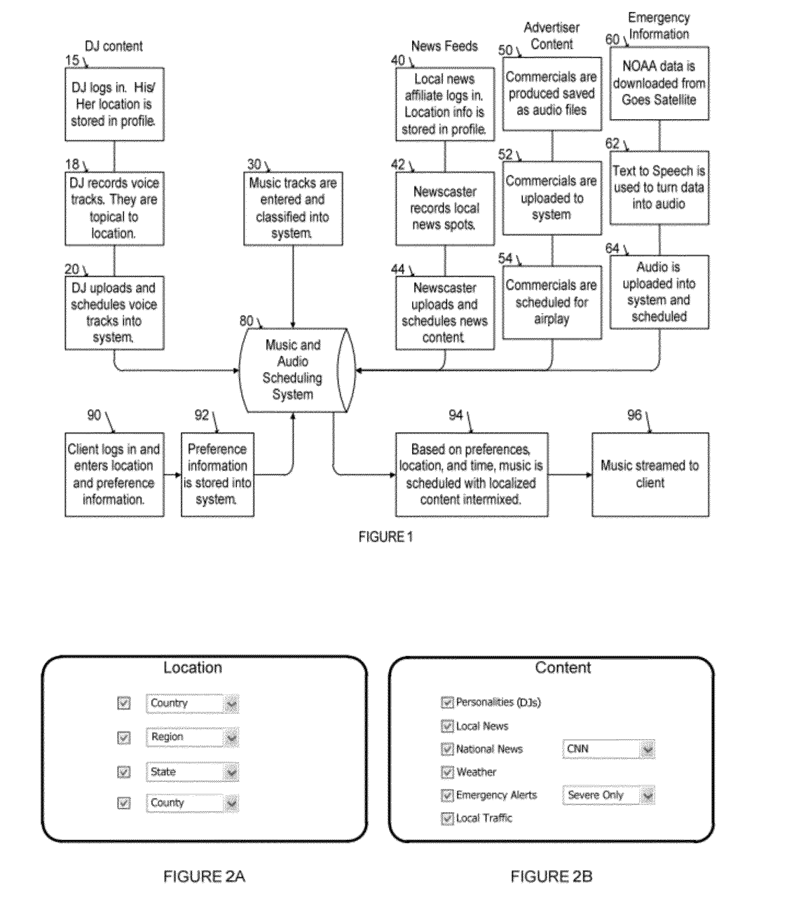

Various categories of local content are inserted into the system and scheduled for playback or streaming to listeners as illustrated in FIG. 1. FIG. 1 illustrates DJ content, news feeds, advertiser content, and emergency information. Each type of content may be scheduled for playback at different times. For example, a voice track from a DJ may be scheduled to play back as soon as possible. Such content is most similar to a local, live radio broadcast. Alternatively, the DJ can pre-record a full show or a time slot and schedule the show for playback at a future time. Thus playback times can be configured by the DJ, the system or according to a default playback time.

Weather and emergency information is automatically ingested into the system from all areas of the country. For example, the weather information is downloaded from the GOES weather satellites. Text to speech technology is used to convert that weather information into audio files. These files are also uploaded to the system, categorized and scheduled for playback.

News spots can also be uploaded from various local news outlets, similar to the techniques used to upload DJ voice tracks. Alternatively, a national news organization can provide the news spots that are relevant to one or more locations.

Referring to FIG. 1, at a step 15 a DJ logs into the system with his/her designated location information having been previously provided to and stored as a profile in the system of the invention. At a step 18, the DJ records voice tracks that are topical to the designated location. At a step 20 the DJ uploads the recorded voice tracks to the system and schedules the voice track for playback at a designated time. Alternatively, the system can designate a time for play back of the recorded voice tracks.

At a step 30 music tracks are entered and classified (as to attributes of the music as described elsewhere herein) in the system.

At a step 40 (as related to news feeds), a local news affiliate logs into the system with her/his location information stored in a previously-created news profile. Alternatively, the news person can enter his/her location information. At a step 42 the local news stories (spots) are recorded. At a step 44 the news spots are uploaded and scheduled for payback through the system. Alternatively, the system could automatically pull pre-recorded news recordings from a news affiliate's RSS news feed, publically or privately available.

At a step 50, commercials and other forms of advertising are produced and saved as audio files. The commercials are uploaded to the system at a step 52 and scheduled for playback at a step 54.

Emergency information, such as the depicted NOAA data from a GOES satellite, is downloaded at a step 60 and converted from text to speech to create audio data files at a step 62. At a step 64 the audio content is uploaded to the system and scheduled for playback, most likely immediately or nearly immediately.

Other news events of local interest, road construction and traffic congestion, for example, can be input to the system in a manner similar to the emergency information, but not necessarily scheduled for immediate playback.

Block 80 represents a music and scheduling element that receives the scheduling information input by the content provider as described above, or establishes the playback schedule as desired by the system operator. Alternatively, if individual listener profiles are created, the playback times can be set within a listener profile.

At a step 90, a client (listener) logs into the system and enters location and preference information, which may be stored in the system as indicated at step 92. This location information is input to the block 80, which controls operation of the system. A block 94 indicates that the content is played back or streamed to the listener, who logged in at the block 90, according to the listener's preferences, location, time and selected music style, with the local content entered into the stream, as controlled according to the block 90. At a block 98 the music is streamed to the client/listener.

When operating in the manual location mode, as referred to above, the listener is presented with a first window as illustrated in FIG. 2A. The listener selects his/her locality among a hierarchy of localities from most specific (e.g., county or city) to least specific (country). The system uses this information to choose the appropriate content to be scheduled for later streaming (playback) to the listener.

In FIG. 2B, the listener chooses the types of content she/he would like to receive. Some content types have additional sub-options. For example, the listener can choose, through a drop down window, whether to listen to national news from ABC, CNN, or Fox News. Also, in one embodiment the listener can choose (again through a drop down window) the nature and severity of the emergency alerts to be received.

Personalized Radio with Quality Transitions Between Elements (or Content Items)

This embodiment comprises a method and system for analyzing song endings (referred to as “outros”) and song beginnings (referred to as “intros”) so that they can be overlapped, or transitioned, smoothly from one song to the next song in a personalized music playback system. Thus this embodiment allows internet-delivered music, according to a listener's selections, to be streamed in a personalized fashion, while retaining a smooth overlap between songs such as played by traditional radio stations.

In one embodiment, the system of the present invention analyzes song outros and song intros as they are entered into the system for later streaming. The songs can be either automatically analyzed or a music professional can manually analyze the song and enter specific cue points.

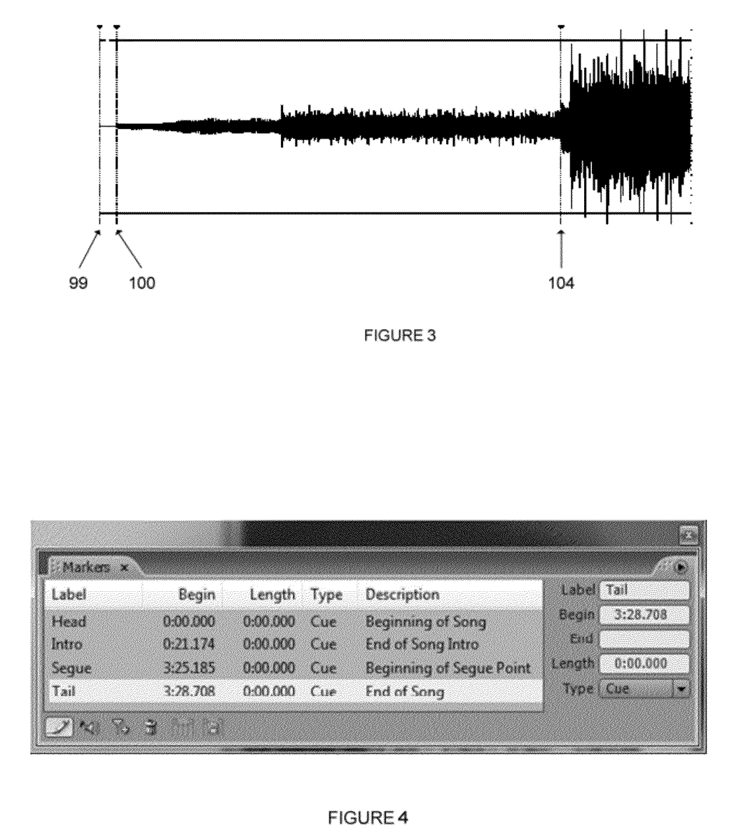

FIG. 3 illustrates a waveform of one exemplary musical selection, where the beginning of the musical selection is indicated by a flat line 99 to the left of the beginning of the music of the musical selection (also referred to as a head point) as indicated by a reference numeral 100. The end of the intro is indicated by a reference numeral 104. Some musical selections may have as long as ten seconds of silence from the beginning to the head point. Therefore the system of the invention does not begin the playback at the beginning of the selection, but instead begins playback at the head point. Talk time for the depicted musical selection is between the head point 100 and the intro point 104.

With reference to FIG. 4, a segue marker denotes the beginning of a segue period or the point in time at which the next musical selection or the next content item begins.

The system further determines songs (i.e., consecutive songs) that can be effectively overlapped or transitioned smoothly from one song to another song in the personalized music playback system of the invention. This allows the music to be selected and arranged in a personalized fashion, while still retaining the smooth song overlap as provided by traditional radio stations.

The system makes such transition decisions based on many criteria including at least the following: tempo, intensity, genre, artist separation, title separation and era. Tempo is determined on the basis of beats per minute. Intensity is based on instrumentation and lyrical content. Genre is a determination of musical style (rock, dance, hip-hop, pop, adult contemporary, praise and worship, country, southern gospel, urban contemporary, choir music, etc.). Artist and title separation are based on looking back at the system's history of specific listener exposure and response to said artist and song in question (For example, was it marked as a favorite or skipped, if skipped, how many times?). Era is the year in which a song was released to the public.

Because songs are recorded by different people in different locations, the result is music with varying tonal balance, varying volume levels, and varying dynamic densities. For the listener of a system that does not take this into consideration, the musical variations are significant. One song may sound “bright,” which means the song has too many high-frequencies in the mix. Another may sound “dull,” meaning the song has the opposite tone coloration. One may sound very loud and another very soft. These differences from one song to the next require the listener to frequently adjust the playback level and other playback parameters of his/her system. Or the listener will perceive the music produced by the system as not having a pleasing sound.

Thus the inventive system analyzes and adjusts the song audio characteristics so that the tonal quality of the sound is substantially consistent from one musical selection to the next musical selection.

To implement these features, each musical selection is analyzed as it is input to the system. The total length of the musical selection, the length of the song intro, and the length of the song outro are stored in a database. The system analyzes the data associated with a currently-playing song and the data associated with the next scheduled song and determines the appropriate amount of overlap between the two consecutive selections. The system then automatically starts the next song before the previous song ends to create the desired overlap length.

The duration of the overlap and the time interval of the overlap (i.e., relative to each of the two consecutive musical selections) are dependent on the type of element (e.g., musical selection, advertisement) that is ending and the type of element that will then begin. For example, for two consecutive musical selections, the intro for a second of the two selections (i.e., the intro song) is started at the segue point of the first selection (i.e., the outro song), provided that the intro duration is shorter than the time interval between outro's segue and the outro's tail, i.e., the end of the outro song (or more generally, the end of any song). Ideally, one wishes to avoid lyrics of the second song overlapping with the outro interval of the first song.

For segueing from a musical selection to a voice track, again it is necessary to ensure that the voice track duration is longer than the interval between the outro segue point and the tail.

For segueing from a voice track to a musical selection, the later must be started sufficiently late so that the voice track has finished before the intro talk time of the musical selection has finished.

The volume level at the end of the first song or the beginning of the second song may need to be reduced or faded to make the transition work well or to allow a voice track to play over the music.

Each of these techniques, when applied to the play back of internet radio selections, makes the transitions between broadcast elements similar to the transitions created by a broadcast radio station.

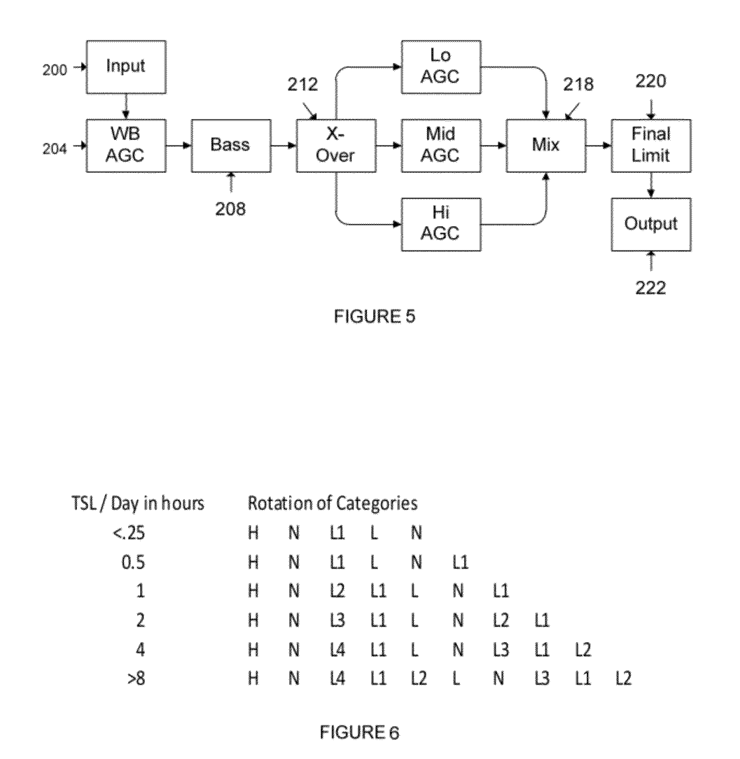

The system utilizes processes to determine the volume level and tonal balance of the audio recordings before they are encoded (digitally compressed) for playback. The data associated with the overlap length and any necessary music fades is stored and coupled to the digital data encoding the songs. FIG. 5 shows a software flowchart for a program that processes the audio file to make its dynamics and spectral balance more consistent with other audio content in the system.

The elements shown within FIG. 5 are common to traditional radio dynamics processing, but are not typically used in personalized internet streaming systems. A musical selection is input (as indicated by an input block 200) to a wide band automatic gain control (WB AGC) block 204. WB AGC process controls the overall volume level of the input musical selection. A bass block 208 allows specific tailoring of lower frequencies within the musical selection. A cross-over block 212 segregates the selection into high frequencies, mid-range frequencies, and low frequencies. The three frequency bands are then individually processed (not separately depicted) for dynamic sound levels. This technique balances the tonal content, making the music sound more consistent from the high frequencies to the low frequencies. The three frequency band signals are then mixed together in a mixer 218. A final limiter 220 ensures the full mixed audio signal does not overdrive or distort before the musical selection exits the system process through an output block 222.

The above-described FIG. 5 elements can be adjusted either manually or automatically to achieve the desired tonal quality of a musical selection.

The right side of FIG. 5 indicates the amount of dynamic adjustment made to the musical selection under consideration. It illustrates, in a real time display, the amount of adjustment implemented as the process settings are changed. When the desired settings are achieved, the processing of the musical selection occurs in the background in a non-real time fashion.

Personalized Radio with Traditional Radio Music Selection Influence

This embodiment incorporates traditional broadcast radio music selection influences and listener feedback into a personalized radio system. Traditional radio stations employ staff members tasked with choosing musical selections they believe the station's listeners will enjoy. This embodiment combines these traditional processes with the interactive input available from personalized radio systems to create better music selections for delivery to listeners over internet-based radio.

Generally, the system of the invention uses a personalized radio listener's input and combines this data with the traditional professional rating categorization methods employed in the radio arena to identify better music selections for a listener.

Songs in the system of the invention are classified using both quantitative and qualitative data. Quantitative data may include, for example, song length, artist, composer, style, genre, tempo, etc. Qualitative (or subjective) data is an indicator of the quality or popularity of a song as determined by music professionals and by the listening public. Generally, each qualitative element or qualitative characteristic (e.g., popularity) is given a ranking between a lowest ranking and a highest ranking. For example, a numerical scale can be used for this purpose with a score of 10 representing the highest ranking and a score of 1 indicating the lowest ranking.

A listener requests music satisfying certain specified quantitative data and categories, such as genre and/or tempo, be played back. The system then selects, according to the listener-selected quantitative categories, the musical selections that have the highest ranking for the qualitative categories and that satisfy the listener-selected quantitative categories. As a result of this dual matching technique, the listener is more likely to receive music selections that she/he will enjoy.

When a song is entered into the system of the invention for the first time, if a publicly available “rank” is available for the song, commonly a 1 through 5 star system, it is stored in the system as an “Initial Rating”. Then this song is evaluated by a music professional on staff. This person ranks the song in terms of quality and merit. This initial impression from the music professional is stored as a “Pro Rating”. As songs are played through the system, the client/listener is given the opportunity to also rate the song. The average of all clients' ratings is stored as a “Popular Rating” for the song.

After a song has been played many times by a radio station or by another internet-based radio, the song becomes more familiar to a typical listener base. The song is then re-analyzed by a selected set of listeners of both traditional radio and internet-based radio. This re-ranking process can be conducted either in person individually or by a group. The re-ranking can also be accomplished through a specialized internet service.

According to one embodiment, to re-rank a song an excerpt of the song is played (in one embodiment the excerpt is about 20 seconds long) and each listener from the group of listeners is asked to offer either a “like” or “dislike” response. In another embodiment each listener is asked to select a quantitative score for each song. The music professional uses the data gathered in the internet surveys or group tests to update the ranking stored in the Pro Rating.

Finally all of this data is re-calculated based on the number of Popular Ratings the song has been given, the average of the Popular Ratings, and the number of times the song has been played. The final calculated song rating is stored as the “Calculated Rating.”

The song's final Calculated Rating, along with the age of the song is used to classify the song into specific music categories. These categories are used to build a better music mix for the listener. The categories include, but are not limited to:

| | |
|---|---|
| Heavy | Current song in heavy rotation. |
| Light | Current song in light rotation (either brand new or coming out |
| | of the heavy category). |
| Nuclear | Gold song testing in the top 15% of all gold songs in |
| | popularity. |
| Level 1 | Gold song testing in the top 25% of all gold songs in |
| | popularity. |
| Level 2 | Gold song testing in the top 35% of all gold songs in |
| | popularity. |
| Level 3 | Gold song testing in the top 50% of all gold songs in |
| | popularity. |
| Level 4 | Gold song testing in the lower 50% of all gold songs in |
| | popularity. |

In broadcast radio vernacular, a “current” song is typically defined as one that is relatively new. A “gold” song is not new, but is still considered a good song worthy of airplay.

The internet-based radio station can then select a song play list (exemplary play lists are set forth in FIG. 6) including all or some of the calculated rating categories set forth above and an order for playing musical selections from the various rating categories.

Common complaints of traditional radio listeners are that a station “plays a song too often” or “I never hear my favorite songs.” One reason for these justified comments is that the traditional radio station is building one music mix to cover all of its listeners' needs. The station tries to balance the competing interests of ensuring the hottest music is played often while still offering a broad music mix. The problem arises for the listener who listens for only a few minutes each day. This listener needs to hear a good (popular) song each time she/he turns on the radio. At the other end of the listener spectrum, people who listen for multiple hours a day will typically hear the same songs played again and again. Traditional broadcast radio cannot please everyone.

The system of the invention also analyzes the listener's current Time Spent Listening (TSL), which is the total amount of time the listener has spent listening in a given period of time. For the listener who has a low TSL, the system automatically adjusts the music mix to include more popular songs in a more frequent rotation (or songs that have scored high on a different qualitative measure). For example, for a listener with a relatively low TSL value, the system may supply musical selections that have a relatively high score or ranking for the qualitative elements (such as popularity). For a listener with a high TSL value, the system can supply musical selections that have a lower score or ranking for the qualitative elements. This technique thus increases the likelihood that within a relatively short time the listener hears a song she/he likes. For the listener with a high TSL, the system adjusts the music mix to include a larger selection of music and the selections are repeated less frequently.

FIG. 6 depicts an exemplary music mix rotation as a function of a listener's TSL. Exemplary TSL values are listed in the first column and rotation categories are indicated in subsequent columns. When a rotation through the indicated category is completed (one horizontal line) the rotation begins again. For lower TSL values the number of music categories associated with one rotation is correspondingly lower (the period through one rotation is shortened) and the number of rotations made in a given time interval is therefore increased. For longer TSL values a greater number of music categories are associated with one rotation and the number of rotations in a given time interval is therefore reduced. The Li reference in FIG. 4 refers to any level 1-4.

Personalized Radio with Listener Directed Metric Control

This embodiment of the system of the invention combines personalized radio with full music metric control, allowing the listener to fully control the type of music she/he hears. Rather than permitting a system to choose the music for him/her by selecting songs that are “similar” to songs the listener has indicated he/she enjoys, the system begins with a musical genre and/or sub-genre and adds several additional musical metric options to give the listener greater control of the music selections received.

As music tracks are entered into the system of the invention, many pieces of qualifying information are included as metadata corresponding to the metrics, as described elsewhere herein, associated with the song. As the listener starts his/her music selection for the first time, she/he is asked to select from a list of music genres. The listener can select only one genre or select multiple genres.

In addition to the genre selections, optional features (metrics) that the listener can select include, but are not limited to:
Era—A time period when the song was released.
Popularity—This metric includes hit music that is currently popular or was popular when first released, songs that were not successful upon release or thereafter, and songs that were not released to radio (i.e., commonly referred to as “deep cuts”).
Label—Music represented by major labels or independent labels.
Frequency—Time period before a song is replayed.

Each metric can be assigned a default value of N/A (not selected) in which case the not selected metric has no influence on the music selected for the listener.

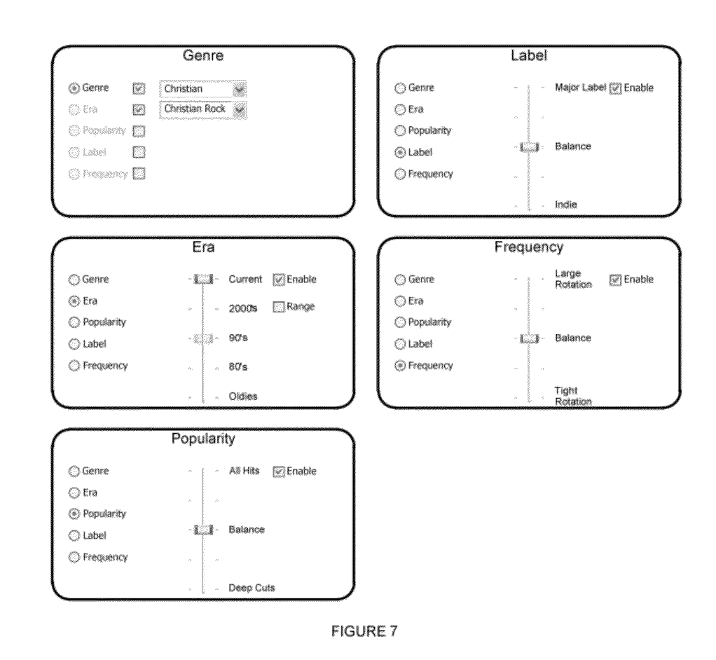

An exemplary screen shot (window) of the some metric categories is illustrated in FIG. 7. As can be seen, a vertical slider allows the user to select any metric value between an upper and a lower limit for certain ones of the metrics. Similar display windows with various sub-menus can also be implemented on smart phones.

Listener metric selections can then be saved as presets or “stations” on the listener's player. Each version of the listener's player, whether it is resident on a desktop computer, smart phone, or another delivery device, can access (and change) all of the listener's metrics. This allows the listener to make preference changes whenever and wherever he/she is and independent of the listening device.

Allowing the listener the ability to adjust these various metrics gives the listener much more control over the type of music that she/he will hear, providing a superior listening experience.

According to one embodiment, the genre placed first on the list is given the highest priority. Alternatively, the listener is able to assign a priority metric or weight to each selected genre. For example, the priority metric may be based on a scale of a hundred, for example in percentage terms. The first genre may be given a priority ranking of 50%, with 30% assigned to the second genre and 20% assigned to the third genre. Further, during the last week of November the listener may wish to hear some Christmas music, so she/he adds Christmas music to the priority list and assigns it a 10% priority. As Christmas approaches the listener's Christmas mood becomes more prominent and so the listener selects a priority of 50% for Christmas music, for example. After the initial genre(s) has been selected, the system allows further customization of the selected genres and the priority assigned to each.

Listener selections can be saved as presets or “stations.” Each version of the listener's player, whether it is resident on a desktop computer, smart phone, or another delivery device, can access (and change) all of the listener's metrics. This allows the listener to make preference changes whenever and wherever they are and independently of the listening device.

Personalized Radio with Dynamic Bandwidth Control

This embodiment comprises a method for analyzing audio playback statistics and dynamically adjusting the audio quality/data bandwidth. This feature allows the best audio playback quality for the available data bandwidth, reducing the audio quality when the data bandwidth is limited. The result is an increased likelihood that the listening experience is not interrupted by audio dropouts and the audio fidelity is maximized for the given data availability.

This embodiment of the system of the present invention analyzes the data streaming statistics of the data connection between the listener and the origin of the data stream carrying the content items. The system automatically adjusts the audio quality to remain within the capability of the data connection. Since most internet-based personalized radio systems use pre-compressed audio files, the quality level and corresponding data size is determined before playback. The providers of this service typically try to strike a balance between providing high quality audio and data size. But for the audio to play on lower quality (e.g., slower speed) networks, such as a cellular data network, the file size must be reduced, resulting in a reduced sonic musical quality.

The embodiment records the audio files into the system at multiple quality/size levels. The larger sizes allow for virtual CD quality (and can include surround sound playback features). Smaller data sizes allow for playback over lower quality cellular connections or dial-up home connections with expected diminished fidelity.

During initial setup the system executes a data connection test phase on the client side to determine how much bandwidth is available and sets the audio quality level to an appropriate value. During playback, if the system detects that the data connection cannot keep up with the streaming rate or is near the limit of maintaining that streaming rate, the system automatically selects the next lower level of audio quality and data size. If this reduced data rate is successful, playback continues for a period of time.

The system may later increase the audio quality (by providing more data at a higher data rate) and again determine if the data rate can be maintained because the data connection has improved. This back and forth process maintains the best quality listening experience possible.

Personalized Radio for the Business Listening Environment

This embodiment adds business environment functionality to a personalized internet radio system to create a customized background music system for the business. This embodiment allows a business to select a custom music selection, interleave that selection with customized business recordings for announcements, and further includes features for reporting and paying music royalty fees.

As music tracks are entered into the system of the invention, many pieces of qualifying information are included as metadata corresponding to the metrics described elsewhere herein. When the business first activates the system, it is prompted to select from a list of music genres. The business can select only one genre or multiple genres.

After the genre(s) have been selected, the system allows further customization of the playback selections. Optional settings (metrics) include, but are not limited to:
Era—Songs related to a particular time period or to events that occurred during that time period.
Popularity—Hit music that is currently popular, songs that were popular when first released, songs that were not successful upon release or thereafter, or songs that were not released to radio (i.e., “deep cuts”). Label—Music represented by major labels or independent labels.
Frequency—Time period before a song is replayed.

Each metric can be assigned a default value of N/A (not selected) in which case the not-selected metric has no influence on the music selected.

An exemplary screen shot (window) of the some metric selections is illustrated in FIG. 7. As can be seen, a vertical slider allows the user to select any metric value between an upper and a lower limit for certain ones of the metrics.

Once the selections have been made, they can be saved as presets or “stations.” In addition, the system allows the business to upload digital recordings that might include advertisements, marketing information, or general announcements, especially related to the business. The user can schedule how often the announcements are to be played or schedule specific times for playing the announcements. For example, the business can schedule “closing” announcements at the end of business hours (e.g., “you must leave the store now”), and other announcements at a specific time each day (e.g., daily “blue light” specials).

The various data elements described herein (e.g., outro length, qualitative elements) that are associated with content items (e.g., musical selections or voice tracks), can be stored as metadata for the content item. Other techniques and systems for linking the data elements to the content items are also known by those skilled in the art.

As known in the art, it may also be necessary to compress the data files (content items and metadata) for transmission over the internet. The compression format is selectable and a specific format is not required for operation of the present invention.

Although the concepts of the various embodiments of the invention have been described with respect to a personal computer, (including at least laptop computers, netbooks, tablet computers, workstations, servers) those skilled in the art recognize that these concepts can also be applied to any device capable of accessing the Internet through which content is delivered. Such devices include, but are not limited to: smart phones, personal digital assistants, single purpose appliances, computers, etc.

Broadly speaking, the invention teaches a method, apparatus, and program for determining providing personalized internet-based radio broadcasts. To facilitate an understanding of the present invention, it is described with reference to specific implementations thereof.

The embodiments of the present invention may be implemented in the general context of computer-executable instructions, such as program modules executed by a computer. Generally, program modules include routines, programs, objects, components, data structures, etc. that perform particular tasks or implement particular abstract data types. For example, the software programs that underlie the invention can be coded in different languages for use with different platforms. The principles that underlie the invention can be implemented with other types of computer software technologies as well.

Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Persons skilled in the art will recognize that an apparatus, such as a data processing system, including a CPU, memory, I/O, program storage, a connecting bus, and other appropriate components, could be programmed or otherwise designed to facilitate the practice of the method of the invention. Such a system would include appropriate program features for executing the method of the invention.

Also, an article of manufacture, such as a pre-recorded disk or other similar computer program product, for use with a data processing system, could include a storage medium and a program stored thereon for directing the data processing system to facilitate the practice of the method of the invention. Such apparatus and articles of manufacture also fall within the spirit and scope of the invention.

The present invention can be embodied in the form of computer-implemented processes and apparatuses for practicing those processes. The present invention can also be embodied in the form of computer program code containing computer-readable instructions embodied in tangible media, such as floppy diskettes, CD-ROMs, hard disks, flash drives or any other computer-readable storage medium, wherein, when the computer program code is loaded into and executed by a computer or processor, the computer or processor becomes an apparatus for practicing the invention. The present invention can also be embodied in the form of computer program code, for example, whether stored in a storage medium or loaded into and/or executed by a computer, wherein, when the computer program code is loaded into and executed by a computer or processor, the computer or processor becomes an apparatus for practicing the invention. When implemented on a general-purpose computer, the computer program code segments configure the computer to create specific logic circuits or processing modules.

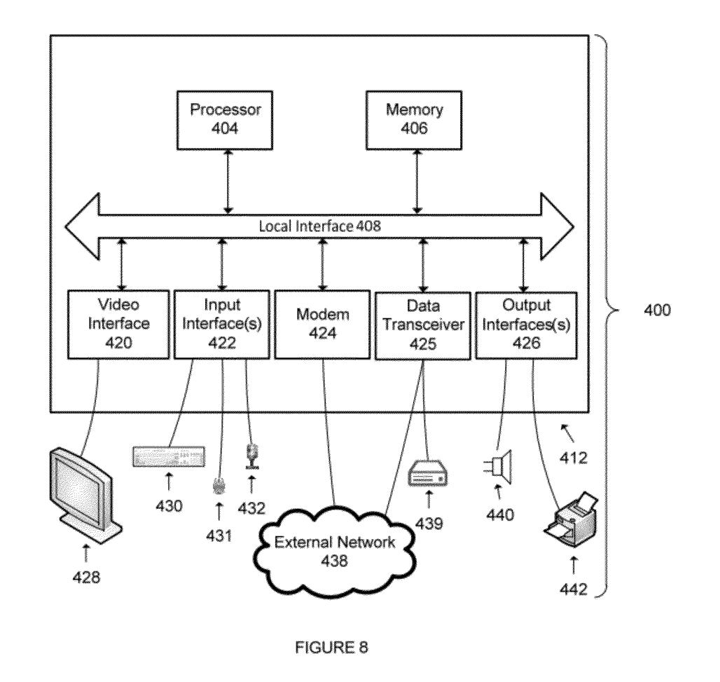

FIG. 8 illustrates a computer system 400 for use in practicing the invention. The system 400 can include multiple remotely-located computers and/or processors. The computer system 400 comprises one or more processors 404 for executing instructions in the form of computer code to carry out a specified logic routine that implements the teachings of the present invention. The computer system 400 further comprises a memory 406 for storing data, software, logic routine instructions, computer programs, files, operating system instructions, and the like, as is well known in the art. The memory 406 can comprise several devices, for example, volatile and non-volatile memory components further comprising a random access memory RAM, a read only memory ROM, hard disks, floppy disks, compact disks including, but not limited to, CD-ROM, DVD-ROM, and CD-RW, tapes, flash drives and/or other memory components. The system 400 further comprises associated drives and players for these memory types.

In a multiple computer embodiment, the processor 404 comprises multiple processors on one or more computer systems linked locally or remotely. According to one embodiment, various tasks associated with the present invention may be segregated so that different tasks can be executed by different computers located locally or remotely from each other.

The processor 404 and the memory 406 are coupled to a local interface 408. The local interface 408 comprises, for example, a data bus with an accompanying control bus, or a network between a processor and/or processors and/or memory or memories. In various embodiments, the computer system 400 further comprises a video interface 420, one or more input interfaces 422, a modem 424 and/or a data transceiver interface device 425. The computer system 400 further comprises an output interface 426. The system 400 further comprises a display 428. The graphical user interface referred to above may be presented on the display 428. The system 400 may further comprise several input devices (not shown) including, but not limited to, a keyboard 430, a mouse 431, a microphone 432, a digital camera and a scanner (the latter two not shown). The data transceiver 425 interfaces with a hard disk drive 439 where software programs, including software instructions for implementing the present invention are stored.

The modem 424 and/or data transreceiver 425 can be coupled to an external network 438 enabling the computer system 400 to send and receive data signals, voice signals, video signals and the like via the external network438 as is well known in the art. The system 400 also comprises output devices coupled to the output interface 426, such as an audio speaker 440, a printer 442, and the like.

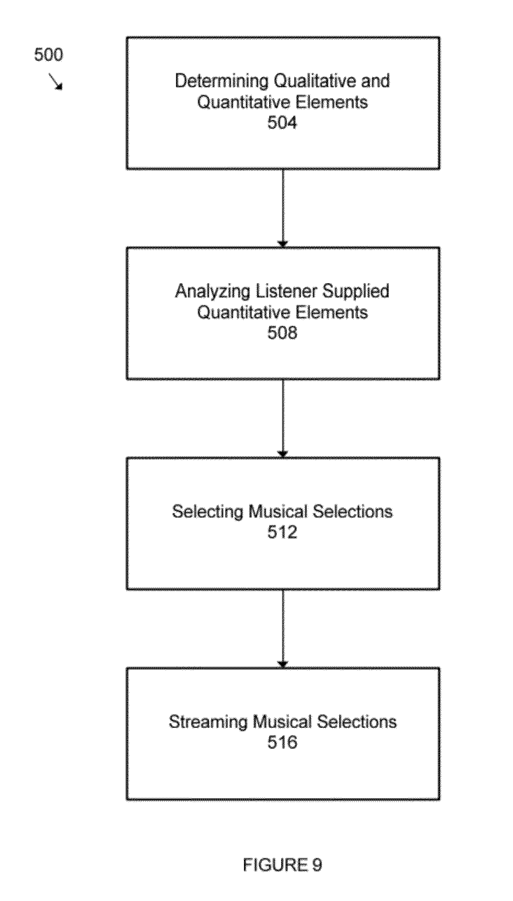

FIG. 9 is a flow chart 500 for implementation by the computer system 400 of FIG. 8. The flowchart 500 begins at a step 504 for determining one or more qualitative elements and/or quantitative elements of a plurality of musical selections or other content items. A step 508 analyzes listener-supplied quantitative elements. At a step 512, musical selections that satisfy listener-supplied quantitative elements and that were assigned high-ranking scores (where high-ranking is defined by the system operator) for qualitative elements are selected. At a step 516 musical selections selected at the step 512 are streamed to the listener.

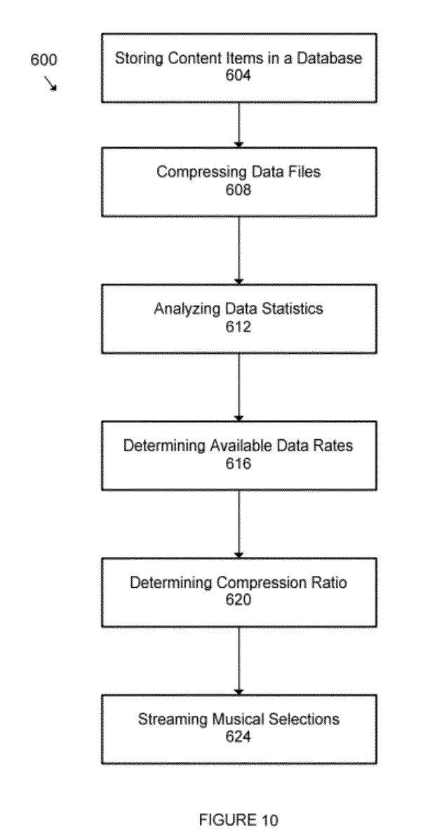

FIG. 10 is a flow chart 600 for implementation by the computer system 400 of FIG. 8. Each content item is stored as a digital file at a step 604. At a step 608 each digital file is compressed according to a plurality of different data compression ratios and the compressed files are stored. Step 612 analyzes data statistics associated with the data connection between the internet web site and the listener. Step 616 determines available data rates according to statistics analyzed at the step 612. Step 620 then determines the best compression ratio for streaming the digital file, where the best (i.e., lowest) available compression ratio is based on the results of the step 616. It is preferred to stream at the highest available data rate and the lowest compression ratio to provide the best quality music to the listener. At step 624 the digital file is streamed to the listener using the lowest available compression ratio.

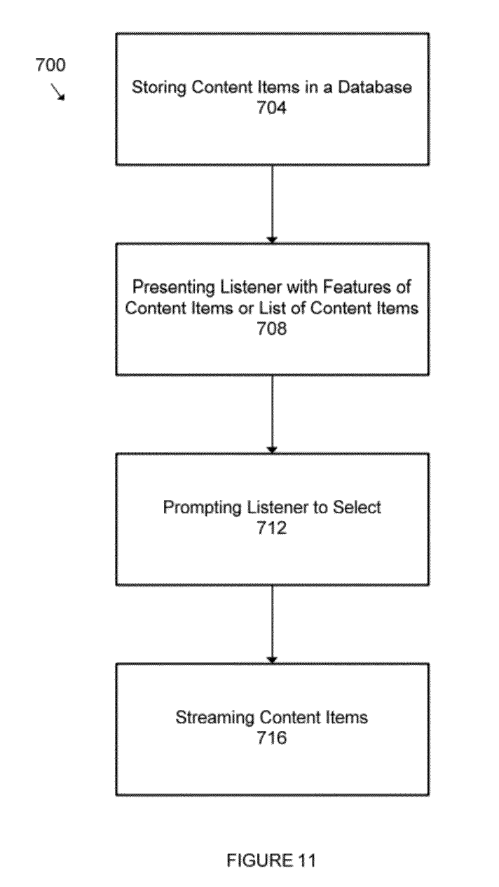

FIG. 11 is a flow chart 700 for implementation by the computer system 400 of FIG. 8. At a step 704 musical and non-musical content items are stored in a data base of the computer system 400. A step 708 presents the internet radio listener with a list of the content items or with a list of the features (attributes) of the content items stored at the step 704. A step 712 prompts the listener to select any desired content items directly or based on the attributes of the content items. Step 716 streams the selected content items or the content items having the desired attributes to the listener.

Although the concepts of the various embodiments of the invention have been described with respect to a personal computer, (including at least laptop computers, netbooks, tablet computers, workstations, servers) those skilled in the art recognize that these concepts can also be applied to any device capable of accessing the Internet through which content is delivered. Such devices include, but are not limited to: smart phones, personal digital assistants, single purpose appliances, etc.

What is claimed is:

1. A method for injecting local content into an internet radio data stream supplied via an internet web site to a listener accessing the internet web site, the method comprising:
(a) storing local content in a data base;
(b) identifying a location of the listener; and
(c) streaming the local content to the listener.

2. The method of claim 1 wherein the step (b) comprises identifying the location of the listener responsive to one of listener-entered location information, a global positioning system device, a geographic look up according to the listener's internet protocol address, and a zip code of the listener.

3. The method of claim 1 wherein the step (c) comprises streaming the local content at predetermined times, as soon as a current music selection ends, or at a time designated by the listener.

4. The method of claim 1 wherein the local content comprises one or more of local disc jockey voice tracks, local news, local weather, local emergency alerts, local business advertisements, and local sports.

5. A method for providing transitions between content items in an internet radio data stream supplied via an internet web site to a listener accessing the internet web site, the method comprising:
(a) analyzing a plurality of content items with respect to one or more of tonal content, length of intro, length of outro, length of content item, segue point, tempo, genre, artist, title, era, tonal balance, volume level, and dynamic density;
(b) storing results from step (a);
(c) determining a first and a second content item that can be overlapped or that can be transitioned responsive to one or more of the results of step (a); and
(d) consecutively streaming the first and second content items to the listener.

6. The method of claim 5 wherein the content items comprise one of more of musical selections and voice tracks.

7. A method for listener selection of musical selections for play back into an internet radio data stream supplied via an internet web site to the listener accessing the internet web site, the method comprising:
(a) determining one or more qualitative elements and one or more quantitative elements of a plurality of musical selections;
(b) analyzing listener-supplied quantitative elements;
(c) selecting musical selections satisfying the listener-supplied quantitative elements and having been assigned scores above a predetermined first threshold for the qualitative elements; and
(d) streaming musical selections selected at step (c) to the listener.

8. The method of claim 7 wherein the qualitative elements comprise at least an indicator of popularity of the musical selection.

9. The method of claim 7 wherein the qualitative elements of step (a) are determined by a music professional.

10. The method of claim 9 wherein step (a) is repeated subsequent to a first execution of step (a), wherein when the step (a) is repeated listener input is supplied to the music professional for use in determining the qualitative elements.

11. The method of claim 7 wherein step (c) further comprises selecting music selections according to a time spent listening of the listener, wherein a second predetermined threshold is used in the step (c), the second predetermined threshold is responsive to the time spent listening.

12. The method of claim 11 wherein for time spent listening values below a threshold value, step (c) selects musical selections having higher scores for one or more qualitative elements.

13. A method for adjusting audio quality of content items of an internet radio data stream supplied via an internet web site to a listener accessing the internet web site, the method comprising:
(a) storing each content item as a digital file;
(b) compressing each digital file according to a plurality of different data compression ratios;
(c) analyzing data statistics of a data connection between the internet web site and the listener;
(d) determining available data rates according to results of step (c);
(e) determining a compression ratio for a digital file responsive to the results of step (d); and
(f) supplying the digital file having the compression ratio determined at step (e) to the listener.

14. The method of claim 13 wherein the data statistics comprise one of data rate and available bandwidth of a transmission link between the internet web site and the listener.

15. The method of claim 13 wherein a content item comprises a musical selection and wherein a quality of a musical selection as played by a listener is responsive to a data compression ratio used to compress a digital file representing the content item as supplied to the listener.

16. The method of claim 13 further comprising determining data statistics at different times while supplying the digital file to the listener and accordingly determining a compression ratio for the digital file supplied to the listener.

17. A method for supplying content items into an internet radio data stream supplied via an internet web site to a business enterprise accessing the internet web site, the method comprising:
(a) storing content items in a data base;
(b) streaming content items to the business enterprise according to metric values previously assigned by the business enterprise; and
(c) including among the content items additional content items related to the business enterprise.

18. The method of claim 17 wherein the content item metrics comprise one or more of musical genre, musical era, musical popularity, and music label.

19. The method of claim 17 wherein the business enterprise can assign a metric value to each content item, and wherein the metric values are considered in streaming content items to the business enterprise.

20. The method of claim 17 wherein the additional content items comprise one or more of marketing information and general announcements, wherein the business enterprise can schedule at least one of a frequency and a time for streaming the additional content items.

21. A method for injecting listener-selected content into an internet radio data stream supplied via an internet web site to a listener accessing the internet web site, the method comprising:
(a) storing musical and non-musical content items in a data base;
(b) presenting the listener with a list of the content items;
(c) requesting the listener to select desired content items; and
(d) streaming the desired content items to the listener.

22. The method of claim 21 wherein the non-musical content items comprise one or more of voice tracks and content items local to a region.
